(19) United States
(12) Patent Application Publication
(10) Pub. No.: US 2003/0001874 A1
(43) Pub. Date: Jan. 2, 2003

(54) Method and apparatus for computer input using the skin as sensory feedback

(75) Inventors: Werner Kriechbaum, Ammerbuch-Breitenholz (DE); Ronald Pfeifer, Nufringen (DE); Gerhard Stenzel, Herrenberg (DE)

Correspondence Address: Leslie A. Van Leeuwen, International Business Machines Corporation, Intellectual Property Law Department, 11400 Burnet Road, Austin, TX, 78758, US

(73) Assignee: International Business Machines Corporation, Armonk, NY (US)

(21) Appl. No.: 10/142,612

(22) Filed: May 9, 2002

(30) Foreign Application Priority Data
Jun. 27, 2001 (EP) 01115449.9

(51) Int. Cl. G09G 5/00

(52) U.S. Cl. 345/701

(57) ABSTRACT

The present invention relates to method and system for entering information for processing by a computing device. In order to improve the manual entering of information specially in so-called “non-desktop” environments or for visually impaired users as for example blind persons or car drivers while driving a car it is proposed to use a part of the human skin (11) as a feedback organ when entering information. Therefore, an information entering device (10) is provided having a pressure-sensing area (12) for decoding exerted pressure patterns and transform them into an information input signal, and a contact area (16) able to be coupled between said pressure-sensing area (12) and a respective part of the human skin (11) or clothes covering it. The exerted pressure patterns are conducted to the skin (11) whereby a respective sensory feedback is provided to the person.

### 1. BACKGROUND OF THE INVENTION

1.1. Field of the Invention

The present invention relates to method and system for entering information into an entering device for processing by a computing device, and in particular to mobile devices.

1.2. Description and Disadvantages of Prior Art

Such prior art entering devices are for example the so-called touch-pads of a notebook. With the touch-pad a person enters information into a mobile computer by moving the finger along the touch-pad sensing area, and by realising a click or a double click onto a particular location the mouse pointer was navigated to. A double click action is usually an information which encodes some kind of action trigger, for example the start of a program when the mouse pointer was navigated before to a respective program icon. This information entering procedure requires a visual feedback from the user otherwise he is not able to know where the mouse pointer is.

A second prior art entering device in particular adapted to mobile devices are pressure-sensitive display areas, such as those realised in some hand-held computers, organisers and the like. Here, pressure may be exerted with a stick having a smooth tip and single characters can be generated by a person by “writing” on said sensing display. When, for example exerting a circle like pressure pattern the user also receives a visual feedback from the display because he sees a black circle on a light display surface. A post-connected character recognition algorithm converts the pressure pattern into an ASCII character for further processing within the computing device.

A problem arises, however, when visually-impaired persons want to enter non-oral information, i.e., manually by the fingers or a pencil-like stick because they are unable to receive the before-mentioned visual feedback. Without such feedback, however, the person is not sure what information has been entered. Thus, this remains insecure and must be corrected in a later point in time in which this is much more difficult—if possible at all—compared to the immediate time of entering.

A similar situation is occurred when a temporarily, visually impaired person, like for example a car driver while driving is considered. In this case, as well as in others, the entering person has to watch something else which is more important than the entering device. Thus, with prior art technique, for visually impaired persons the entering of information is difficult.

1.3. Objectives of the Invention

It is thus an objective of the present invention to provide a method and system for entering information for processing in a computing device, which is able to be used by visually-impaired persons.

### 2. SUMMARY AND ADVANTAGES OF THE INVENTION

This objective of the invention is achieved by the features stated in enclosed independent claims. Further advantageous arrangements and embodiments of the invention are set forth in the respective subclaims. Reference should now be made to the appended claims.

According to a first aspect of the invention a method for entering information for processing by a computing device is disclosed, characterized by the step of:

a.) exerting a pressure pattern onto a pressure-sensitive area of an entry device arrangeable to be brought into pressure contact with a part of the human skin, and

b.) using the human tactile sensation caused by the exerted pressure pattern for a feedback while entering information into said device.

According to a second aspect thereof an information entry device for entering information for processing by a computing device is disclosed having a pressure-sensing layer area able to decode exerted pressure patterns and to transform them into an information input signal, and a contact layer area able to be coupled between said pressure sensing layer area and a respective part of the human skin or clothes covering the skin, in which the entry device is arranged to conduct the exerted pressure patterns from the pressure sensing area to the skin such that a feedback is sensible for a person exerting the pressure pattern.

When the entry device comprises a plurality of current-conducting elements which resolves the location of exerted pressure by X-Y perpendicular cross point resolution, and the contact area being arranged as a flexible, pressure conducting foil, then a useful simple structure is provided for the entry device, and prior art touchpad technology can be partly used for fabricating the entry device according to the invention.

According to said both aspects, at least YES/NO signals can be decoded by the device with a minimum of entry driver program, for example a slash for YES, and a dot for NO.

Or other patterns like characters, numbers, etc. may be entered. Thus, the entry device when coupled via any suitable connection—wireless or cable—to a computing device, for example a hand-held PC, organizer, mobile phone, etc., may be used for entering information into said device when a respective entry driver program is active therein.

According to the invention visually impaired persons have a feedback while entering information because they feel the exerted pressure pattern with their skin. The more complicated the entered pattern the more important becomes the feedback information sensible by the skin.

The flexibility of the entry device is primarily required for adapting the entry device shape to the individual form of the human skin surface at an adapted body location, for example the palm of a hand, the thigh, the arms, etc.

According to the invention the ability of the device to conduct the (manually) exerted pressure pattern to the skin may be basically reached either by providing a flexible device structure soft and thin enough, for example by using thin outer foils as mentioned above, or, or in combination with, by using a flexible structure which is not necessarily soft, but arranged differently for conducting the pressure pattern, for example via mechanical pressure conduction.

Thus, pressure-conducting elements—for example a net layer consisting of a matrix-like or hexagonal, area-filling arrangement of interconnected plastic cuboids might be provided within the top and bottom layers of the device, advantageously between sensing area and skin contact area, and/ or between protection layer and pressure sensing area. With this type of structure quite robust entry devices can be fabricated which keep good sensitivity capability.

When said elements have a smooth surface, e.g. when they are coated with Teflon® or the like, they might slide easily in contact to each other, thus achieving a good pattern resolution.

When, further, the sensing area is divided into a plurality of separate pressure sensitive portions, each portion encoding a predetermined information or data, when pressed, any desired prior,art entry device can be simulated, for example the keyboard of a portable phone. Further, any function key as for example YES/NO keys can be advantageously added.

Further, the present invention can be also used with clothes when an information entry device as described above is incorporated in the tissue thereof. Then the use of the entry device is very comfortable and no separate entry device must be handled.

### 3. BRIEF DESCRIPTION OF THE DRAWINGS

The present invention is illustrated by way of example and is not limited by the shape of the figures of the drawings in which:

FIG. 1 is a schematic cross-sectional view of an information entry device according to a preferred embodiment of the present invention;

FIG. 2 is a partly representation of the device depicted in FIG. 1 as a detailed schematic top view onto the wiring net, illustrating inventive pressure conducting elements of the device.

### 4. DETAILED DESCRIPTION OF THE PREFERRED EMBODIMENT

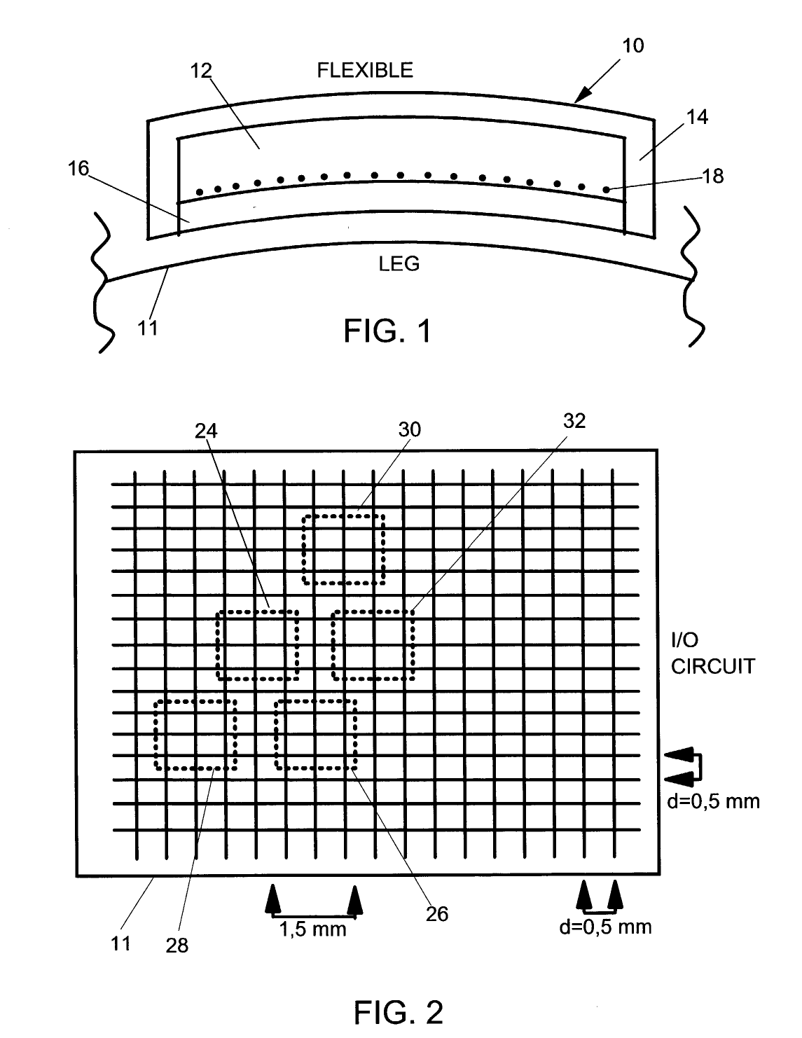

With general reference to the figures and with special reference now to FIG. 1 the entry device according to a preferred embodiment of the invention is depicted as a whole with reference sign 10. Said entry device 10 comprises a pressure-sensing area within a layer 12 which is switched between a protection layer 14 on top of layer 12 and a contact layer 16 beneath layer 12. The pressure-sensing layer 12 comprises a net 18 of wiring elements which are current-conducting and which resolve the location of the exerted pressure by X-Y perpendicular crosspoint resolution as this is done in prior art already, for example in touchpads of a notebook.

The 3-layer structure according to the present embodiment is a simply structured example, only. Therefrom, a compact entry device 10 results which is flexible enough in order to adapt its surface shape with a considerable portion of it to the outer shape of a leg or other part of the human body when the entry device is laid upon said part of the human body. In FIG. 1 this is symbolized by the skin 11 of a leg, which has a curved (horizontal) form as depicted in the drawing.

The upper protection layer 14 is made from a flexible plastic material and is thin enough in order to conduct locally exerted pressure—for example by a finger to the pressure sensing layer 12 with a spatial resolution, for example, of 0,5 to 1 mm as this is already possible with prior art touchpad technology.

The contact layer 16 is also made from a flexible material, for example, from some plastic material and has preferably an outer contact surface for contacting the skin 11 or clothes—not depicted in the drawing for improved clarity thereof—covering the skin which is preferably rough enough in order to avoid sliding away from the skin when this is not intended by the user.

The entry device further comprises a prior art I/O-circuit that collects the X-Y crosspoint positions of the net, which are currently under pressure, when the entry device is operated manually. The I/O circuit is able to forward this information to any kind of adapted IO-interface, for example via infra-red or Blue-Tooth or some conventional cable plug. The entry device 10 comprises further a small battery for producing the supply voltage for the IO-circuit.

The entry device 10 may have a size of for example 10 cm long, 10 cm wide and having a thickness of about 4 mm. When pressure is exerted on some location the device is flexible and pressure-conducting enough in order to conduct the exerted pressure pattern onto specific locations of the skin 11 where respective human nerves are excited and thus enable for a feedback feeling for the user.

With reference now to FIG. 2 a detailed part view onto some inner details within the entry device 10 is given. Additionally, some additional, optional technical feature of pressure-conducting elements is disclosed which results in a modified structure of the device 10.

The wiring net is depicted with reference sign 18. It is symmetric in X and Y direction with an average distance of 0,5 mm between each wire.

As this is a top view the skin 11 surface is symbolically depicted as an area 11. Some of the crosspoints of the wiring is depicted with reference sign 22.

According to a preferred embodiment of the invention a plurality of pressure-conducting elements 20 are arranged such they build up a further layer preferably without gaps between individual elements 20. Five pressure conducting elements 20, 24, 26, 28, 30, 32 are exemplarily depicted in FIG. 2. In reality, there is a large plurality of them in a single entry device.

The pressure conducting elements preferably build up rows along the entire width of the entry device which are preferably set up in parallel rows touching each other smoothly and having an offset of the half of the width of an individual pressure conducting element as it is depicted in FIG. 2. Preferably, the conducting elements of a row might be joint together with a thin thread coupling them loosely and avoiding the elements to leave the regular order in which they are intended to stay. Furthermore, “columns” of them might also be interconnected in the same way.

Each individual pressure-conducting element 20 is 1,5 mm wide and 1,5 mm long. The length is dependent of the flexibility of the device. In case they are not interconnected by threads or other things the elements 20 must basically be long enough in order to avoid that an element may be pushed beneath another one and thus leaves the layer which is built up by the entirety of the pressure conducting elements.

The pressure conducting elements can be preferably made from any synthetic material, like plastics, and have advantageously a smooth wall surface in order to enable for easy sliding against each other.

By virtue of said pressure conducting element 20 a pressure pattern, for example a simple slash having a width of 3 mm and a length of 20 mm is conducted with a high special resolution to the skin 11. Thus, a quite precise feedback feeling is provided to the user when entering, for example the above mentioned slash, or any other pattern, a dot, a curved pattern, a character, or a number, or handwritings.

Thus, from the above description a person skilled in the art will appreciate that a pressure pattern may easily reach the skin even if there are quite thin clothes between-the entry device and the skin. Basically, the pressure-conducting elements need not to be used when the entry device is soft and thin enough to conduct the pressure pattern to the skin.

In the foregoing specification the invention has been described with reference to a specific exemplary embodiment thereof. It will, however, be evident that various modifications and changes may be made thereto without departing from the broader spirit and scope of the invention as set forth in the appended claims. The specification and drawings are accordingly to be regarded as illustrative rather than in a restrictive sense.

Those skilled in the art will not fail to realize that the sensor can be incorporated into the fabric by using touch sensitive threads as soon as they are available as a commodity item.

1. A method for entering information for processing by a computing device, characterized by the step of:
a.) exerting a pressure pattern onto a pressure-sensitive area of an entry device (10), arrangeable to be brought into pressure contact with a part of the human skin (11), and
b.) using the human feeling caused by the exerted pressure pattern for a feedback while entering information into said device (10).

2. An information entry device (10) for entering information for processing by a computing device, having a pressure-sensing area (12) able to decode exerted pressure patterns and transform them into an information input signal, and a contact (16) area able to be coupled between said pressure sensing area and a respective part of the human skin or clothes covering the skin, in which the entry device (10) is arranged to conduct the exerted pressure patterns from the pressure sensing area (12) to the skin (11) such that a feedback feeling is sensible for a person exerting the pressure pattern.

3. The information entry device (10) according to the preceding claim in which the pressure sensing area (12) comprises a net (18) of current-conducting elements which resolves the location of exerted pressure by X-Y perpendicular cross point resolution, and the contact area (16) being arranged as a flexible, pressure conducting foil.

4. The information entry device (10) according to claim 2 in which the sensing area (12) is divided into a plurality of separate pressure sensitive portions, each portion encoding a predetermined information or data, when pressed.

5. The information entry device (10) according to claim 2 further comprising pressure conducting elements (20, 24, 26, 28, 30, 32) within the outer layers (14, 16) of the device (10), and in particular between sensing area (12) and skin contact area (16), and/or between protection layer (14) and pressure sensing area (12).

6. The information entry device (10) according to the preceding claim in which the pressure conducting elements (20, 24, 26, 28, 30, 32) have a smooth surface.

7. Clothes having an information entry device (10) according to one of the claims 2-4 incorporated in the tissue thereof.
